(19) United States
(12) Patent Application Publication
(10) Pub. No.: US 2025/0142231 A1
(43) Pub. Date: May 1, 2025

(54) DEVICE, SYSTEM, AND MOVING BODY

(71) Applicant: CANON KABUSHIKI KAISHA, Tokyo (JP)

(72) Inventor: HIROSHI SEKINE, Kanagawa (JP)

(21) Appl. No.: 18/918,975

(22) Filed: Oct. 17, 2024

(30) Foreign Application Priority Data
Nov. 1, 2023 (JP) 2023-187536

(51) Int. Cl. H04N 25/771

(52) U.S. Cl. CPC H04N 25/771

(57) ABSTRACT

A device includes pixels including a sensor unit to generate signals upon incidence of photons and a counter to count the signals, and a control unit. A count value is generated, and one frame has a first count period and a second count period shorter than the first count period. The control unit causes the count value generated during the second count period to be output from end of the second count period to end of the first count period. The sensor unit includes a first region of pixels where counting is performed during the first count period and a second region of pixels where counting is performed during the second count period. The second region is narrower than the first region and the control unit continues counting in the first and second regions from start of the first count period to end of the first count period.

### BACKGROUND

### Technical Field

The aspect of the embodiments relates to a photoelectric conversion device, system and a moving body.

### Description of the Related Art

A photoelectric conversion device configured to count the number of photons incident on an avalanche photodiode (APD) and to output the counted value from a pixel as a digital signal has recently been developed. For example, Japanese Patent Application Laid-Open No. 2021-153346 discusses a configuration of a photoelectric conversion device including an APD in which a plurality of video images with count periods overlapping each other can be output and continuous shooting can be performed even under a low illuminance. Japanese Patent Application Laid-Open No. 2021-34786 discusses a configuration for reading out signals at a high frame rate from a pixel region in which a moving subject is detected.

For example, in an image sensor of a camera, recognition processing is performed for each frame in a normal driving operation.

Accordingly, even when an object falls into the angle of view of the camera immediately after switching of the frame, recognition processing cannot be applied until the end of the frame.

On the other hand, if the frame rate is increased, a strong noise occurs under a low illuminance environment.

This further leads to an increase in the amount of data and power consumption.

### SUMMARY

According to an aspect of the embodiments, a device includes a plurality of pixels each including a sensor unit for generating a signal upon incidence of a photon and a counter for counting the signal, and a control unit. A count value is generated based on a difference between a value held in the counter at a start of a count period and a value held in the counter at an end of the count period, and one frame has at least a first count period and a second count period that is shorter than the first count period. The control unit causes the count value generated during the second count period to be output during a period from an end of the second count period and an end of the first count period. The sensor unit includes a first region and a second region, the first region including at least one pixel in which the signal is counted during the first count period among the plurality of pixels, the second region including at least one pixel in which the signal is counted during the second count period among the plurality of pixels. The second region is narrower than the first region. The control unit continues counting in both the first region and the second region during a period from a start of the first count period to the end of the first count period.

Further features of the disclosure will become apparent from the following description of exemplary embodiments with reference to the attached drawings.

### BRIEF DESCRIPTION OF THE DRAWINGS

FIG. 1 is a schematic view of a photoelectric conversion device according to an exemplary embodiment.

FIG. 2 schematically illustrates a pixel substrate of the photoelectric conversion device according to the exemplary embodiment.

FIG. 3 schematically illustrates a circuit substrate of the photoelectric conversion device according to the exemplary embodiment.

FIG. 4 illustrates a configuration example of a pixel circuit of the photoelectric conversion device according to the exemplary embodiment.

FIGS. 5A and 5B schematically illustrate driving of the pixel circuit of the photoelectric conversion device according to the exemplary embodiment.

FIG. 6 is a block diagram illustrating functional blocks of the photoelectric conversion device according to the exemplary embodiment.

FIGS. 7A and 7B each schematically illustrate a readout driving operation of a photoelectric conversion device according to a comparative example.

FIG. 8 schematically illustrates a pixel region of a photoelectric conversion device according to a first exemplary embodiment.

FIG. 9 schematically illustrates a readout driving operation of the photoelectric conversion device according to the first exemplary embodiment.

FIG. 10 schematically illustrates a pixel region of a photoelectric conversion device according to a second exemplary embodiment.

FIG. 11 schematically illustrates a readout driving operation of the photoelectric conversion device according to the second exemplary embodiment.

FIGS. 12A to 12D each schematically illustrate a pixel region of a photoelectric conversion device according to a modified example.

FIG. 13 illustrates a signal processing sequence for the photoelectric conversion device according to the first exemplary embodiment.

FIG. 14 is a functional block diagram illustrating a photoelectric conversion system according to a third exemplary embodiment.

FIGS. 15A and 15B are functional block diagrams illustrating a photoelectric conversion system according to a fourth exemplary embodiment.

FIG. 16 is a functional block diagram illustrating a photoelectric conversion system according to a fifth exemplary embodiment.

FIG. 17 is a functional block diagram illustrating a photoelectric conversion system according to a sixth exemplary embodiment.

FIGS. 18A and 18B are functional block diagrams illustrating a photoelectric conversion system according to a seventh exemplary embodiment.

FIGS. 19A and 19B are functional block diagrams illustrating a photoelectric conversion system according to an eighth exemplary embodiment.

### DESCRIPTION OF THE EMBODIMENTS

The following exemplary embodiments are intended to embody the technical idea of the disclosure and do not limit the disclosure. Some of the sizes and positional relationships of members illustrated in the drawings may be exaggerated for clarity of description. In the following description, the same components are denoted by the same reference numerals, and descriptions thereof may be omitted.

Exemplary embodiments of the disclosure will be described in detail below with reference to the drawings. In the following description, the terms which designate specific directions or positions (e.g., “up”, “down”, “right”, “left”, and other terms including such terms) are used as needed. Such terms are used to facilitate understanding of the exemplary embodiments with reference to the drawings, and the technical scope of the disclosure is not limited by the meanings of the terms.

The term “planar view” as used herein refers to a view in a direction perpendicular to a light incidence surface of a semiconductor substrate. The term “sectional view” as used herein refers to a view of a surface perpendicular to the light incidence surface of the semiconductor substrate. If the light incidence surface of the semiconductor substrate is a rough surface when the surface is viewed microscopically, the planar view is defined based on the light incidence surface of the semiconductor layer when viewed macroscopically.

A semiconductor layer includes a first surface and a second surface that is opposite to the first surface. Light is incident on the second surface.

The term “depth direction” as used herein refers to a direction toward the second surface from the first surface of the semiconductor layer on which an avalanche photodiode (APD) is located. Hereinafter, the “first surface” may be referred to as a “front surface”, and the “second surface” may be referred to as a “back surface”. The “depth” at a certain point or a certain region within the semiconductor layer means the distance of the point or the region from the first surface (front surface). When there are two points, i.e., a point (or region) Z1 of which the distance (depth) from the first surface is d1 and a point (or region) Z2 of which the distance (depth) from the first surface is d2, and d1>d2 holds, this may be expressed as “Z1 is deeper than Z2”, or “Z2 is shallower than Z1”.Further, when there is a point (or region) Z3 of which the distance (depth) from the first surface is d3, and d1>d3>d2 holds, this may be expressed as “Z3 is at a depth between Z1 and Z2”, “Z3 is between Z1 and Z2 with respect to the depth direction”, or the like.

In the following description, assume that the anode of the APD is set to a fixed potential and a signal is taken out of the cathode of the APD. Accordingly, a semiconductor region of a first conductivity type where electric charges having the same polarity as that of signal charges are the majority carriers is an n-type semiconductor region, and a semiconductor region of a second conductivity type where electric charges having a polarity different from that of signal charges are the majority carriers is a p-type semiconductor region.

The aspect of the embodiments is also applicable to a configuration in which the cathode of the APD is set to a fixed potential and a signal is taken out of the anode of the APD. In this case, the semiconductor region of the first conductivity type where electric charges having the same polarity as that of signal charges are the majority carriers is the p-type semiconductor region, and the semiconductor region of the second conductivity type where electric charges having a polarity different from that of signal charges are the majority carriers is the n-type semiconductor region. A configuration example where either one of the nodes of the APD is set to a fixed potential will be described below. However, both nodes of the APD may be variable in potential.

When the term “impurity concentration” is used in the present specification, this means the net impurity concentration, with the amount compensated for by inverse conducting type impurity subtracted. That is, “impurity concentration” indicates the net doping concentration. A region in which a doped impurity concentration of p-type dopant is higher than a doped impurity concentration of n-type dopant is a p-type semiconductor region. In contrast, a region in which the doped impurity concentration of n-type dopant is higher than the doped impurity concentration of p-type dopant is an n-type semiconductor region.

In the following exemplary embodiments, connections between circuit elements may also be mentioned. In this case, even in a case where there is another element between elements of interest, the elements of interest are treated as connected, unless otherwise noted. For example, assume that an element A is connected to one node of a capacitive element C having a plurality of nodes, and an element B is connected to another node of the capacitive element C. Even in such a case, the elements A and B are treated as connected, unless otherwise noted.

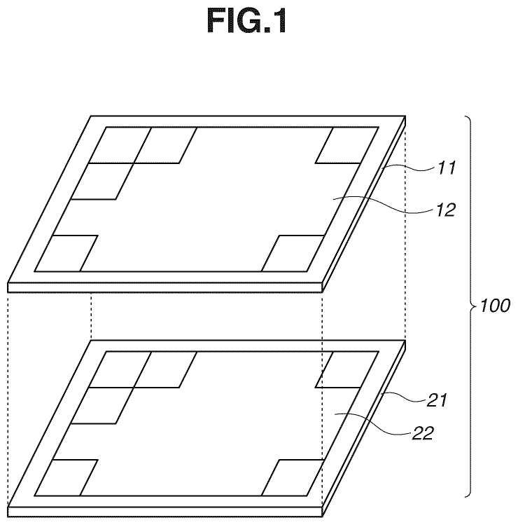

A configuration common to a photoelectric conversion device and a driving method thereof according to exemplary embodiments of the disclosure will be described with reference to FIGS. 1 to 5B.

FIG. 1 illustrates a configuration example of a photoelectric conversion device 100 according to an exemplary embodiment of the disclosure. Hereinafter, an example will be described where the photoelectric conversion device 100 is a stacked photoelectric conversion device. Specifically, the photoelectric conversion device 100 having a configuration in which two substrates, i.e., a sensor substrate 11 and a circuit substrate 21 are stacked and electrically connected will be described by way of the example. However, the configuration of the photoelectric conversion device 100 is not limited to this example. For example, the photoelectric conversion device 100 may have a configuration in which components included in the sensor substrate 11 and components included in the circuit substrate 21 are provided in a common semiconductor layer as described below. In the following description, the photoelectric conversion device 100 having a configuration in which components included in the sensor substrate 11 and components included in the circuit substrate 21 are provided in a common semiconductor layer is also referred to as a non-stacked photoelectric conversion device.

The sensor substrate 11 includes a first semiconductor layer including a photoelectric conversion unit 102 to be described below and a first wiring structure. The circuit substrate 21 includes a second semiconductor layer including circuits such as a signal processing unit 103 to be described below, and a second wiring structure. The photoelectric conversion device 100 has a configuration in which the second semiconductor layer, the second wiring structure, the first wiring structure, and the first semiconductor layer are stacked in this order.

FIG. 1 illustrates an example of a back-illuminated photoelectric conversion device having a configuration in which the circuit substrate 21 is provided on the second surface which is opposite to the first surface and on which light from the second surface is incident. In the non-stacked photoelectric conversion device, the surface on which a transistor of a signal processing circuit is provided is referred to as the second surface. In a back-illuminated photoelectric conversion device, the first surface opposite to the second surface of the semiconductor layer corresponds to the light incidence surface. In a front-illuminated photoelectric conversion device, the second surface of the semiconductor layer corresponds to the light incidence surface.

The following description is made assuming that the sensor substrate 11 and the circuit substrate 21 are diced chips. However, the sensor substrate 11 and the circuit substrate 21 are not limited to diced chips. For example, the sensor substrate 11 and the circuit substrate 21 may be wafers. Alternatively, the sensor substrate 11 and the circuit substrate 21 may be stacked in a wafer state and then diced, or may be formed into chips and the chips may be stacked and joined together.

The sensor substrate 11 is provided with a pixel region 12 (sensor unit), and the circuit substrate 21 is provided with a circuit region 22 for processing signals detected in the pixel region 12.

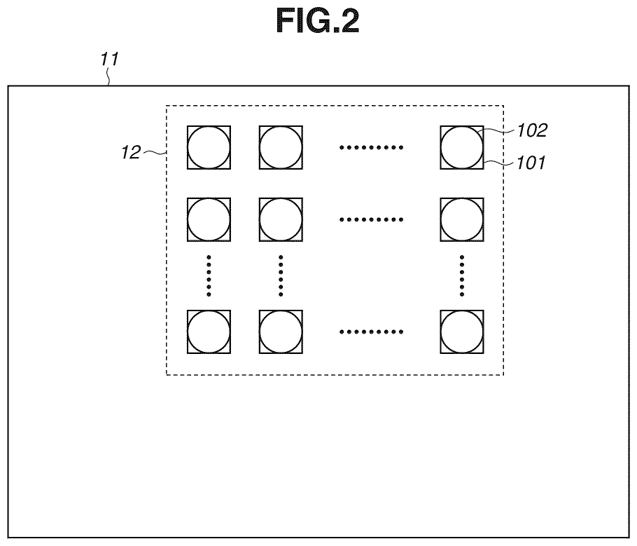

FIG. 2 is a diagram illustrating a layout example of the sensor substrate 11. Pixels 101 each including the photoelectric conversion unit 102 including an APD are arrayed in a two-dimensional manner and form the pixel region 12.

The pixels 101 are typically pixels for forming an image. If the pixels 101 are used for Time of Flight (ToF), the pixels 101 need not necessarily form an image. In other words, the pixels 101 may be pixels for measuring time when light has arrived and measuring the amount of light.

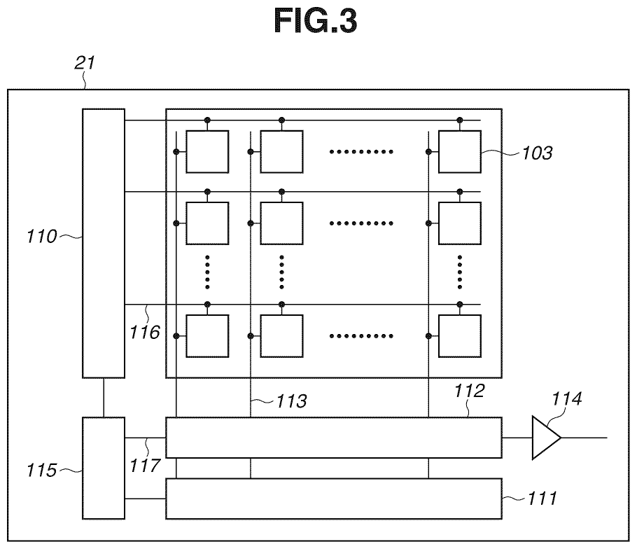

FIG. 3 is a configuration diagram illustrating the circuit substrate 21. The circuit substrate 21 includes the signal processing unit 103 for processing electric charges photoelectrically converted by the photoelectric conversion unit 102 illustrated in FIG. 2, a readout circuit 112, a control pulse generation unit 115, a horizontal scanning circuit unit 111, a signal line 113, and a vertical scanning circuit unit 110.

The photoelectric conversion unit 102 illustrated in FIG. 2 and the signal processing unit 103 illustrated in FIG. 3 are electrically connected via a connection wire provided for each pixel 101.

The vertical scanning circuit unit 110 receives a control pulse supplied from the control pulse generation unit 115, and supplies the control pulses to each of the pixels 101. In the vertical scanning circuit unit 110, a logic circuit, such as a shift register and an address decoder, is used.

The control pulse generation unit 115 includes a signal generation unit that generates a control signal P_CLK for a switch to be described below. The signal generation unit generates a pulse signal for controlling the switch as described below. For example, the signal generation unit may generate the control signal P_CLK common to the plurality of pixels 101 in the pixel region, or may generate the control signal P_CLK for each pixel 101. In the case of generating the pulse signal P_CLK common to the plurality of pixels 101, the common signal P_CLK is generated such that at least one of a cycle, the number of pulses, and a pulse width of a pulse signal of a signal for controlling the exposure period corresponds to the exposure period. In the case of controlling the control signal P_CLK for each pixel 101, an input signal output from the control pulse generation unit 115 and the signal for controlling the exposure period can be used to generate the control signal P_CLK. In one embodiment, the control pulse generation unit 115 may include, for example, a frequency divider circuit. This makes it possible to simply perform control processing and reduce an increase in the number of elements.

The signals output from the photoelectric conversion unit 102 in each pixel 101 are processed by the signal processing unit 103. The signal processing unit 103 is provided with a counter, a memory, and the like, and digital values are held in the memory.

The horizontal scanning circuit unit 111 inputs a control pulse for sequentially selecting columns to the signal processing unit 103 to read out signals from the memory in each pixel 101 in which digital signals are held.

Signals are output to the signal line 113 from the signal processing unit 103 in each pixel 101 selected by the vertical scanning circuit unit 110 in the selected column.

The signals output to the signal line 113 are output to an external storage unit or the signal processing unit of the photoelectric conversion device 100 via an output circuit 114.

In the configuration example illustrated in FIG. 2, the pixels 101 in the pixel region 12 may be one-dimensionally arranged. The functions of the signal processing unit 103 may not be provided to every one of the pixels 101. For example, one signal processing unit 103 may be shared by a plurality of pixels 101 and signal processing may be sequentially performed.

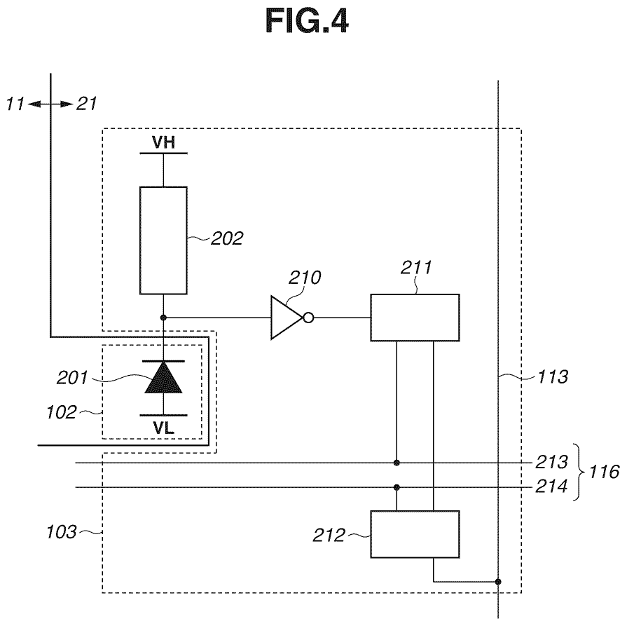

FIG. 4 is an example of a block diagram including equivalent circuits illustrated in FIGS. 2 and 3. In the configuration example illustrated in FIG. 2, the photoelectric conversion unit 102 including an APD 201 is provided in or on the sensor substrate 11 and the other members are provided in or on the circuit substrate 21.

The APD 201 generates electric charge pairs in accordance with incident light by using photoelectric conversion. A voltage VL (first voltage) is supplied to the anode of the APD 201. A voltage VH (second voltage) that is higher than the voltage VL supplied to the anode is supplied to the cathode of the APD 201. A reverse bias voltage is supplied to the anode and the cathode so that the APD 201 performs an avalanche multiplication operation. In the state in which such a voltage is supplied, electric charges generated by incident light cause avalanche multiplication, so that an avalanche current is generated.

In a case where a reverse bias voltage is supplied, there are two modes, i.e., a Geiger mode and a linear mode. The Geiger mode causes the APD 201 to operate in a state where the potential difference between the anode and the cathode is greater than a breakdown voltage. The linear mode causes the APD 201 to operate in a state where the potential difference between the anode and the cathode is around or no more than the breakdown voltage. An APD that operates in the Geiger mode is called a single-photon avalanche diode (SPAD). For example, the voltage VL (first voltage) is −30 V (volts) and the voltage VH (second voltage) is 1 V. The APD 201 may be operated in the linear mode or may be operated in the Geiger mode. The potential difference in the SPAD is greater than that in the APD in the linear mode and the effects voltage withstanding are markedly pronounced.

A switch 202 is connected to each of the APD 201 and a control line supplied with the drive voltage VH. The switch 202 is connected to one of the anode and the cathode of the APD 201.

The switch 202 switches the potential difference between the anode and the cathode of the APD 201 to one of a first potential difference for causing the APD 201 to perform an avalanche multiplication and a second potential difference for not causing the APD 201 to perform an avalanche multiplication. Hereinafter, switching from the second potential difference to the first potential difference is also referred to as “ON” of the switch 202, and switching from the first potential difference to the second potential difference is also referred to as “OFF” of the switch 202. The switch 202 functions as a quenching element. The switch 202 functions as a load circuit (quenching circuit) during signal multiplication by avalanche multiplication, and has a function (quenching operation) of suppressing a voltage to be supplied to the APD 201, thereby suppressing avalanche multiplication. The switch 202 also has a function (recharge operation) of causing a current corresponding to a voltage drop to flow in the quenching operation to return the voltage to be supplied to the APD 201 to the drive voltage VH. In other words, the switch 202 functions as a control circuit for controlling the occurrence of avalanche multiplication in the APD 201.

The switch 202 can be composed of, for example, a metal oxide semiconductor (MOS) transistor. The control signal P_CLK for the switch 202 that is supplied from the signal generation unit is applied to a gate electrode of the MOS transistor constituting the switch 202. In the present exemplary embodiment, the voltage applied to the gate electrode of the switch 202 is controlled to thereby control ON and OFF of the switch 202.

The signal processing unit 103 includes a waveform shaping unit 210, a counter circuit 211, and a selection circuit 212. In the present exemplary embodiment, the signal processing unit 103 may include at least one of the waveform shaping unit 210, the counter circuit 211, and the selection circuit 212.

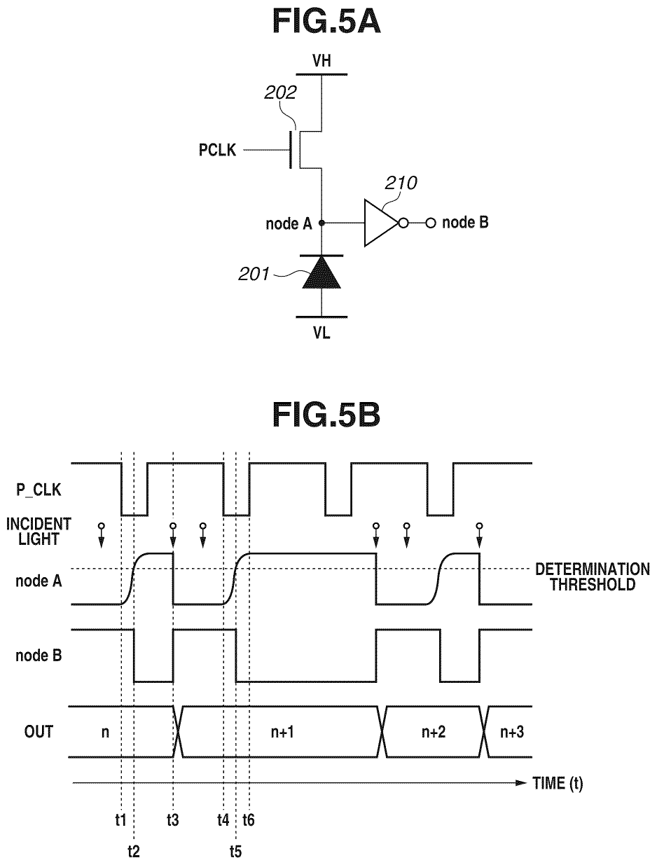

The waveform shaping unit 210 shapes a potential change at the cathode of the APD 201, which is obtained upon detection of a photon, and outputs a pulse signal. An input-side node of the waveform shaping unit 210 is referred to as a node A, and an output-side node of the waveform shaping unit 210 is referred to as a node B. The waveform shaping unit 210 changes the output potential from the node B depending on whether the input potential to the node A is higher than or equal to a predetermined value, or lower than the predetermined value. For example, as illustrated in FIG. 5B, when the input potential to the node A is higher than a determination threshold, the output potential from the node B is at a low level. When the input potential to the node A is lower than the determination threshold, the output potential from the node B is at a high level. For example, an inverter circuit is used as the waveform shaping unit 210. While FIG. 4 illustrates an example where one inverter is used as the waveform shaping unit 210, a circuit obtained by connecting a plurality of inverters in series, or another circuit having a waveform shaping effect may be used.

The quenching operation and the recharge operation can be performed using the switch 202 in accordance with the avalanche multiplication in the APD 201. However, electric charges generated in the APD 201 cannot be determined to be output signals at some photon detection timings. For example, assume a case where avalanche multiplication occurs in the APD 201, the potential at the node A is at the low level, and the recharge operation is performed. In general, the determination threshold of the waveform shaping unit 210 is set to a potential higher than the potential difference at which avalanche multiplication occurs in the APD 201. If a photon is incident on the APD 201 in a state where the potential at the node A is lower than the determination threshold and the potential can cause avalanche multiplication in the APD 201 due to the recharge operation, avalanche multiplication occurs in the APD 201, so that the voltage at the node A decreases. In other words, the potential at the node A decreases at a voltage lower than the determination threshold, and thus a potential change crossing the determination threshold does not occur and the output potential from the node B does not change. Accordingly, a detected photon cannot be determined to be a signal even when avalanche multiplication has occurred. Especially, under a high illuminance, photons continuously enter the APD 201 in a short period, and thus incident light is less likely to be determined to be a signal. The number of actual incident photons is thereby likely to be different from the number of output signals even under the high illuminance.

In contrast, the control signal P_CLK is applied to the switch 202 to switch between the ON state and the OFF state of the switch 202, thereby making it possible to determine detected photons to be signals even when the photons continuously enter the APD 201 in a short period. FIG. 5B illustrates an example where the control signal P_CLK is a pulse signal of a repeated cycle. In other words, FIG. 5B illustrates a configuration example where the ON state and the OFF state of the switch 202 are switched at a predetermined clock frequency.

The counter circuit 211 counts pulse signals output from the waveform shaping unit 210, and holds the count value. When a control pulse pRES is supplied via a drive line 213, the signal held in the counter circuit 211 is also reset.

The selection circuit 212 is supplied with a control pulse pSEL from the vertical scanning circuit unit 110 illustrated in FIG. 1 via a drive line 214 illustrated in FIG. 4 (not illustrated in FIG. 3), thereby switching the electrical connection and disconnection between the counter circuit 211 and the signal line 113. The selection circuit 212 includes, for example, a buffer circuit for outputting a signal.

A switch such as a transistor may be provided between the switch 202 and the APD 201 or between the photoelectric conversion unit 102 and the signal processing unit 103, to thereby switch the electrical connection. Similarly, the supply of the voltage VH or the voltage VL to be supplied to the photoelectric conversion unit 102 may be electrically switched by using a switch, such as a transistor.

FIG. 5B schematically illustrates a relationship among the control signal P_CLK for the switch 202, the potential at the node A, the potential at the node B, and the output signal. In the present exemplary embodiment, when the control signal P_CLK is at the high level, the drive voltage VH is less likely to be supplied, and when the control signal P_CLK is at the low level, the drive voltage VH is supplied to the APD 201. The high level of the control signal P_CLK is, for example, 1 V, and the low level of the control signal P_CLK is, for example, 0 V. When the control signal P_CLK is at the high level, the switch 202 is OFF, and when the control signal P_CLK is at the low level, the switch 202 is ON. The resistance value of the switch 202 when the control signal P_CLK is at the high level is higher than the resistance value of the switch 202 when the control signal P_CLK is at the low level. When the control signal P_CLK is at the high level, the recharge operation is less likely to be performed even when avalanche multiplication occurs in the APD 201. Accordingly, the potential to be supplied to the APD 201 is less than or equal to the breakdown voltage of the APD 201. Thus, the avalanche multiplication operation in the APD 201 stops.

As illustrated in FIG. 5A, the switch 202 may be composed of one transistor and the one transistor may perform the quenching operation and the recharge operation. With this configuration, the number of circuits can be reduced as compared to a case where the quenching operation and the recharge operation are performed by different circuit elements, respectively. In particular, in a case where each pixel 101 includes a counter circuit and a signal from the SPAD is read out for each pixel 101, the circuit area to be used for the switch 202 to arrange the counter circuit may be reduced, and the effect of forming the switch 202 using a single transistor is remarkable.

At time t1, the control signal P_CLK changes from the high level to the low level and the switch 202 is turned on, so that the recharge operation of the APD 201 is started. As a result, the potential at the cathode of the APD 201 transitions to the high level. The potential difference between the potentials applied to the anode and the cathode of the APD 201 is brought into the state where the avalanche multiplication operation can be performed. The potential at the cathode is equal to the potential at the node A. Accordingly, when the potential at the cathode transitions from the low level to the high level, the potential at the node A is more than or equal to the determination threshold at time t2. In this case, the pulse signal output from the node B is reversed and changes from the high level to the low level. Thereafter, the potential difference between the drive voltage VH and the drive voltage VL is applied to the APD 201. The control signal P_CLK transitions to the high level and the switch 202 is turned off.

Next, when a photon is incident on the APD 201 at time t3, avalanche multiplication occurs in the APD 201, so that the voltage at the cathode decreases. In other words, the voltage at the node A decreases. As the amount of voltage drop further increases and the voltage difference applied to the APD 201 decreases, at time t2, for example, the avalanche multiplication in the APD 201 stops and the voltage level of the node A stops dropping beyond a certain value. If the voltage at the node A is lower than the determination threshold while the voltage at the node A is decreasing, the voltage at the node B changes from the low level to the high level. In other words, the portion of the output waveform at the node A exceeds the determination threshold is shaped by the waveform shaping unit 210 and is output to the node B as a signal. Then, the signal is counted by the counter circuit 211 and the count value of the counter signal output from the counter circuit 211 is incremented by 1 least significant bit (LSB).

While a photon is incident on the APD 201 during a period between time t3 and time t4, the switch 202 is in the OFF state and the voltage applied to the APD 201 does not have a potential difference at which the avalanche multiplication operation can be performed. Thus, the voltage level at the node A does not exceed the determination threshold.

At time t4, the control signal P_CLK changes from the high level to the low level and the switch 202 is turned on. Along with this operation, a current compensating for a voltage drop flows to the node A from the drive voltage VH and the voltage at the node A transitions to the original voltage level. In this case, the voltage at the node A is more than or equal to the determination threshold at time t5, so that the pulse signal at the node B is reversed and transitions from the high level to the low level.

At time t6, the voltage level at the node A settles at the original voltage level and the control signal P_CLK transitions from the low level to the high level. Accordingly, the switch 202 is turned off. After that, the potential at each node, each signal line, or the like changes in accordance with the control signal P_CLK or the incidence of a photon as described above from time t1 to time t6.

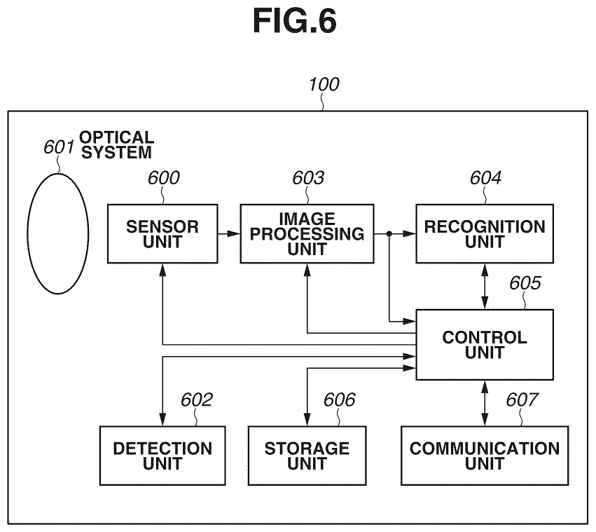

Next, the photoelectric conversion device 100 will now be described. FIG. 6 is a block diagram illustrating functional blocks of the photoelectric conversion device 100. Some of the functional blocks illustrated in FIG. 6 are implemented by causing a computer (not illustrated) included in the photoelectric conversion device 100 to execute a computer program stored in a memory serving as a storage medium (not illustrated).

However, some or all of the functional blocks may be implemented by hardware. A dedicated circuit (application-specific integrated circuit (ASIC)), a processor (reconfigurable processor, digital signal processor (DSP)), or the like can be used as hardware.

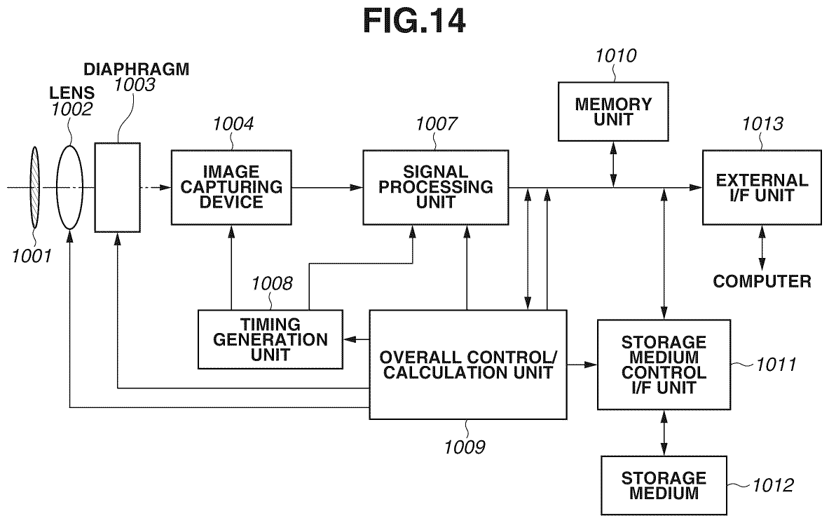

The functional blocks illustrated in FIG. 6 need not necessarily be incorporated in the same housing (or device), but instead may be incorporated in different housings (devices), respectively, which are connected via a signal line. Each functional block may be composed of a device. The above description regarding FIG. 6 also holds true for FIG. 14 to be described below.

The photoelectric conversion device 100 includes a sensor unit 600 including the pixel region 12 described above with reference to FIGS. 1 to 5B, an optical system 601, a detection unit 602, an image processing unit 603, a recognition unit 604, a control unit 605, a storage unit 606, and a communication unit 607. The pixel region 12 is composed of the APD 201 for photoelectrically converting an optical image as described above with reference to FIGS. 1 to 5B.

A camera unit including a set of the optical system 601 and the pixel region 12 is configured to, for example, capture an image of at least one of a front side, a back side, and a side of the photoelectric conversion device 100.

In the present exemplary embodiment, the optical system 601 is, for example, a wide-angle lens (e.g., a fish-eye lens) with an angle of view of 120°, and forms an optical image (subject image) of an object in front of the photoelectric conversion device 100 on an imaging plane of the pixel region 12. The detection unit 602 detects information about the surrounding environment of the photoelectric conversion device 100 (hereinafter referred to as environmental information). The positions and sizes of first and second regions to be described below may be changed depending on an output from the detection unit 602.

The image processing unit 603 performs image processing, such as black level correction, gamma correction, noise reduction, digital gain adjustment, demosaicing processing, or data compression, on the image signal obtained in the pixel region 12, to generate a final image signal. If the pixel region 12 includes an on-chip color filter, such as a red, green, and blue (RGB) color filter, the image processing unit 603 performs processing, such as white balance correction and color conversion.

The output including the image signal from the image processing unit 603 is supplied to the recognition unit 604 and the control unit 605. The recognition unit 604 performs image recognition based on the image signal to recognize a captured image of a person, a vehicle, an object, and the like. The recognition result from the recognition unit 604 is output to the control unit 605, and is reflected in, for example, a change of a control mode for the photoelectric conversion device 100. Further, the recognition result is stored in the storage unit 606 and is transmitted to the outside via the communication unit 607 or the like.

The control unit 605 includes a central processing unit (CPU) serving as a computer and a memory storing computer programs. The control unit 605 also functions as a setting unit and sets the length of an exposure period for each frame of the pixel region 12, a timing control of a control signal CLK, and the like for each of the first and second regions to be described below via the control pulse generation unit 115 in the pixel region 12.

The control unit 605 also functions as an acquisition unit and acquires, as characteristic information about the photoelectric conversion device 100, sensor characteristic information such as the size of the pixel region 12 and the number of pixels, and optical characteristic information such as the angle of view and resolution of the optical system 601. The control unit 605 also acquires information about an installation height, an installation angle, and the like as installation information about the photoelectric conversion device 100 from the detection unit 602, and acquires environmental information about the surrounding environment of the photoelectric conversion device 100 from the detection unit 602.

Based on these pieces of information acquired by the detection unit 602, the CPU executes computer programs stored in the memory incorporated in the control unit 605, to thereby control each unit of the photoelectric conversion device 100.

The storage unit 606 includes, for example, a storage medium such as a memory card and a hard disk, and image signals can be stored in the storage unit 606 and can be read out from the storage unit 606. The communication unit 607 includes a wireless or wired interface, and outputs generated image signals to the outside of the photoelectric conversion device 100 and receives various signals from the outside.

The photoelectric conversion device 100 can be used as, for example, a camera, an in-vehicle camera, a pet camera, a monitoring camera, a camera for detection or inspection to be used on a production line, and a camera for distribution of products. In addition, the photoelectric conversion device 100 can be used for various applications, including an endoscope camera for medical use, a state detection camera for nursing care, a camera for infrastructure checking, and an agricultural camera.

Photoelectric conversion devices according to exemplary embodiments will be described below. In the present exemplary embodiment, an operation of the photoelectric conversion device according to each exemplary embodiment will be described by taking a sample case in which each APD 201 includes a memory at the subsequent stage of the counter and the photoelectric conversion device is operated by so-called global shutter driving. However, the operation of the photoelectric conversion device is not limited to global shutter driving. The beneficial effects of the aspect of the embodiments can also be obtained if the photoelectric conversion device is operated by so-called rolling shutter driving.

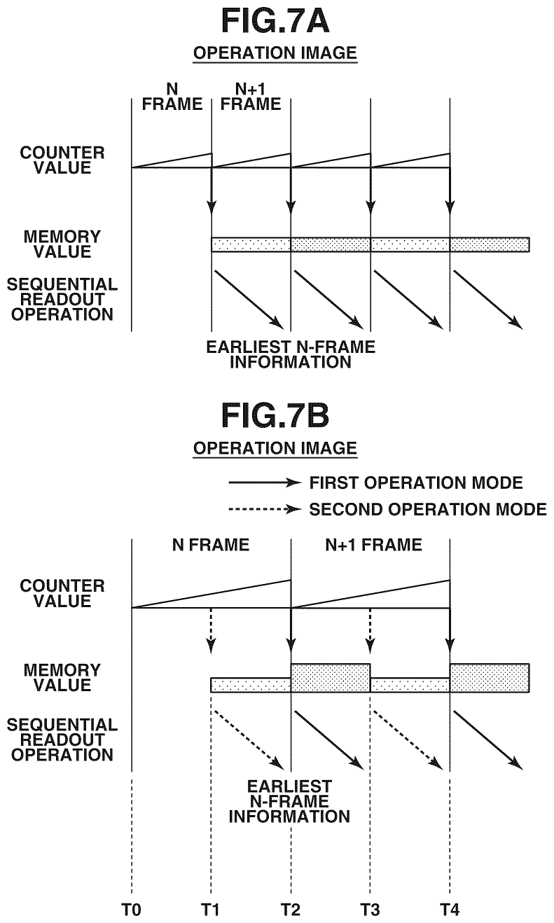

FIGS. 7A and 7B are schematic diagrams each illustrating a readout driving operation of the photoelectric conversion device 100.

FIG. 7A schematically illustrate a readout driving operation of a typical photoelectric conversion device. When one cycle of a readout operation of reading out a signal from each pixel of a pixel array is defined as one frame, the timing of one frame is determined by a time period of a subsequent readout operation to output information from the memory included in each pixel.

In the present exemplary embodiment, the readout driving operation of the photoelectric conversion device 100 is periodically performed at, for example, 30 frames/second.

A signal based on an electric charge generated by an N-frame is counted by the counter circuit 211, and a signal based on a difference between the count value at the start of a count period and the count value at the end of the count period is held in the memory in the signal processing unit 103 as the count value at the end of the N-frame. The count value held in the memory is read out as N-frame information in response to the readout operation to be subsequently performed. In the readout driving operation of related art, the N-frame information can be obtained earliest when the count value obtained in the N-frame is output from the memory during the readout operation on an (N+1)-frame.

FIG. 7B illustrates an example where each frame has a length corresponding to two frames illustrated in FIG. 7A, and each frame includes sub-frames as divided frames each corresponding to the length of one frame illustrated in FIG. 7A. The term “sub-frame” refers to one of a plurality of divided frames in each frame. For example, the N-frame includes a sub-frame N_1 and a sub-frame N_2. The sub-frame N_1 includes a count period from start time T0 to time T1 of the N-frame. The sub-frame N_2 includes a count period from time T0 to time T2.

A first operation mode and a second operation mode are provided as readout operation modes for reading out from the counter and the memory to be performed on each sub-frame. Signals based on electric charges counted in the sub-frame N_1 starting from time T0 are read out and held in the memory at time T1. The count value for the sub-frame N_1 held in the memory is read out from the memory before time T2 by the readout operation to be sequentially performed in the second operation mode. Signals based on electric charges counted in the sub-frame N_2 from time T0 to time T2 are read out and held in the memory at time T2. The count value for the sub-frame N_2 held in the memory is read out from the memory before time T3 by the readout operation to be sequentially performed in the first operation mode.

In the case where the readout operation is performed in the first operation mode, the count value of the counter and the value held in the memory are reset to initial values after the readout operation is executed. On the other hand, in the case where the readout operation is performed in the second operation mode, the signals are continuously held without resetting the count value of the counter and the value held in the memory for the same frame even after the readout operation is executed. With this configuration, an image with the amount of information equivalent to an image obtained by the driving method illustrated in FIG. 7A can be obtained per unit time from the signals output in the first operation mode. in contrast, an image with a larger amount of information per frame than the image obtained by the driving method illustrated in FIG. 7A can be obtained from the signals output in the second operation mode.

In the operations illustrated in FIG. 7A and FIG. 7B, the timing when information about the N-frame is obtained earliest is the time point after the lapse of time T0 to time T1. Even in the case of performing the readout operation illustrated in FIG. 7A, an output equivalent to the signals output in the second operation mode illustrated in FIG. 7B can be obtained by adding the signal from the N-frame and the signal from the (N+1)-frame by using a circuit after the readout operation.

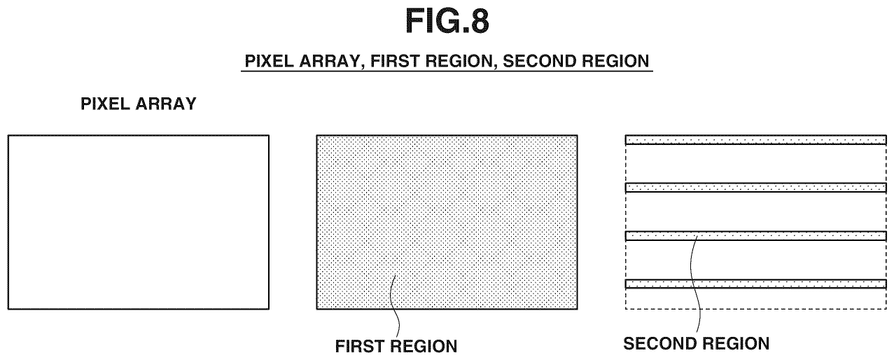

A photoelectric conversion device according to a first exemplary embodiment will now be described with reference to FIGS. 8 to 10.

In the first exemplary embodiment, the first region on which a first readout operation corresponding to a first count value is performed in the first operation mode and the second region on which a second readout operation corresponding to a second count value is performed in the second operation mode are set in the pixel array.

FIG. 8 schematically illustrates a setting status of the first region and the second region in the pixel array of the photoelectric conversion device according to the first exemplary embodiment. In the configuration example illustrated in FIG. 8, the entire pixel region 12 is set as the first region, and a region that is smaller than the first region and is included in the first region is set as the second region. In other words, the second region overlaps the first region.

In the present exemplary embodiment, the pixels are thinned out such that the number of pixels in the second region where signals are read out by the readout operation in the second operation mode is smaller than the number of pixels in the entire pixel region 12, thereby making it possible to increase the frame rate of the second readout operation and to rapidly take out information about each frame. In addition, the number of times of reading out signals in one frame can be increased.

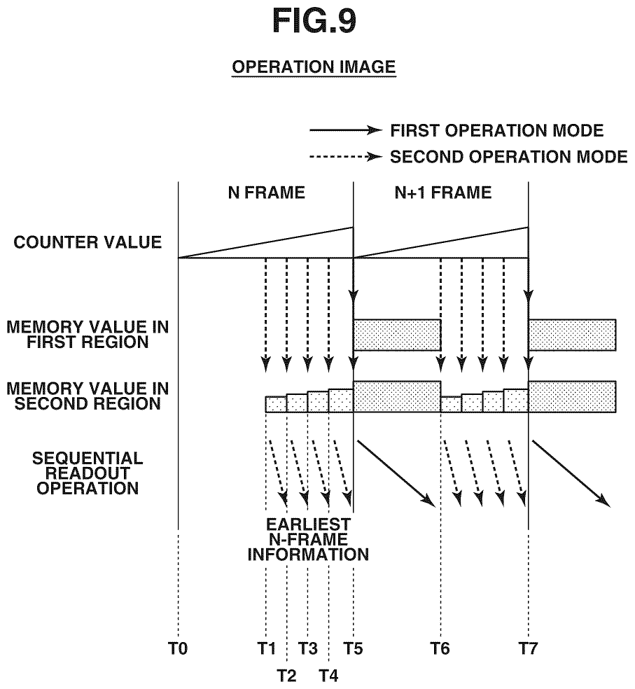

FIG. 9 illustrates a readout operation of the photoelectric conversion device according to the first exemplary embodiment.

FIG. 9 illustrates an example where each frame includes sub-frames. For example, the N-frame includes sub-frames N_1, N_2, N_3, N_4, and N_5. The sub-frame N_1 includes a count period from start time T0 to time T1 of the N-frame. The sub-frame N_2 includes a count period from time T0 to time T2. The sub-frame N_3 includes a count period from time T0 to time T3. The sub-frame N_4 includes a count period from time T0 to time T4. The sub-frame N_5 includes a count period from time T0 to time T5. In this case, time T1 is time corresponding to the middle of the period from time T0 to time T5. Assuming that the period from time T0 to time T1 is a second count period and the period from time T0 to time T2 is a first count period, the second count period is shorter than the first count period.

The count value for the signals corresponding to the pixels in the second region among the signals based on electric charges counted in the sub-frame N_1 starting from time T0 is read out and held in the memory at time T1. The count value held in the memory is read out from the memory before time T2 by the readout operation to be sequentially performed in the second operation mode. After the count value is read out from the memory, the counter is not reset, and the count operation is continued.

The count value for the signals corresponding to the pixels in the second region among the signals based on electric charges counted during the period from time T0 to time T2 is read out and held in the memory at time T2. The count value held in the memory is read out from the memory before time T3 by the readout operation to be sequentially performed in the second operation mode. After the count value is read out from the memory, the counter is not reset, and the count operation is continued.

The count value for the signals corresponding to the pixels in the second region among the signals based on electric charges counted during the period from time T0 to time T3 is read out and held in the memory at time T3. The count value held in the memory is read out from the memory before time T4 by the readout operation to be sequentially performed in the second operation mode. After the count value is read out from the memory, the counter is not reset, and the count operation is continued.

The count value for the signals corresponding to the pixels in the second region among the signals based on electric charges counted during the period from time T0 to time T4 is read out and held in the memory at time T4. The count value held in the memory is read out from the memory before time T5 by the readout operation to be sequentially performed in the second operation mode. After the count value is read out from the memory, the counter is not reset, and the count operation is continued.

The signals based on electric charges counted during the period from time T0 to time T5 are read out and held in the memory at time T5. The count value held in the memory is read out from the memory before time T6. This readout operation corresponds to the first readout operation in the first operation mode on the first count value corresponding to the first region, and the count value for the second region included in the first region is also read out by this readout operation. After the count value is read out from the memory, each counter is reset to the initial value. It can also be said that the end time of the first count period for counting signals corresponding to the pixels in the first region matches the end time of the N-frame.

As described above, according to the first exemplary embodiment, the operation of reading out the count value on the signals counted during the period of the sub-frame N_1 is completed before time T2. Accordingly, a subject can be recognized based on at least the signal counted during the period of the sub-frame N_1. In one embodiment, image recognition can be performed after a lapse of one frame period in the related art, however, image recognition can be performed after a lapse of about ½ frame period at earliest in the present exemplary embodiment. Accordingly, image recognition can be rapidly performed before completion of the N-frame by using the signals.

Similarly, the signals counted in the period of the sub-frame N_2 are sequentially read out during the period from time T1 to time T2. The signals counted in the period of the sub-frame N_3 are sequentially read out during the period from time T2 to time T3. The signals counted in the period of the sub-frame N_4 are sequentially read out during the period from time T3 to time T4. The signals counted in the period of the sub-frame N_5 are sequentially read out during the period from time T4 to time T5. Thus, image recognition can be repeatedly performed before completion of the N-frame. The number of divided frames in each frame is not limited to five, and an any number of sub-frames can be set.

The length of each sub-frame is not limited to the above-described example, and can be arbitrarily set.

An image with a long count period can be used as an image for display because the use of such an image can improve the contrast of the image. In other words, an image with a short count period is suitable for rapid subject recognition and an image with a long count period is suitable as an image for display.

It can also be said that an image with a long count period is suitable for recognition of a subject with a low luminance. The subject recognition can be performed by selecting one of an image with a long counter period and an image with a short count period depending on the luminance of the subject.

In the present exemplary embodiment, an APD is used as the photoelectric conversion device. Accordingly, in the case of reading out signals, no readout noise is superimposed and degradation of signals due to the readout noise does not occur even when the readout operation is performed a plurality of times during an electric charge accumulation period.

Also, in this driving method, the earliest timing when information about the N-frame can be obtained is determined by the time period of the readout operation in the first operation mode.

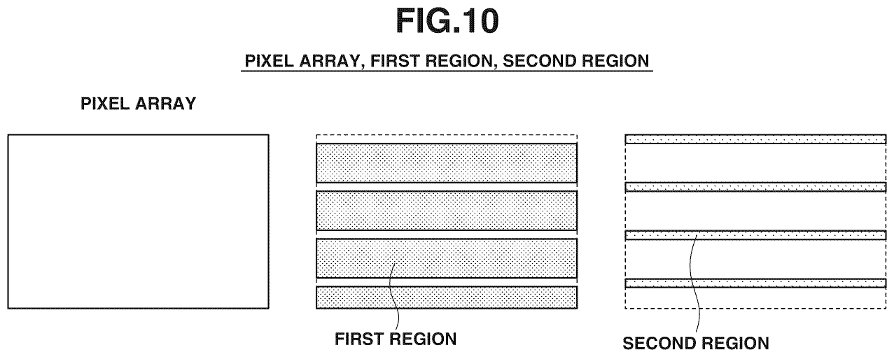

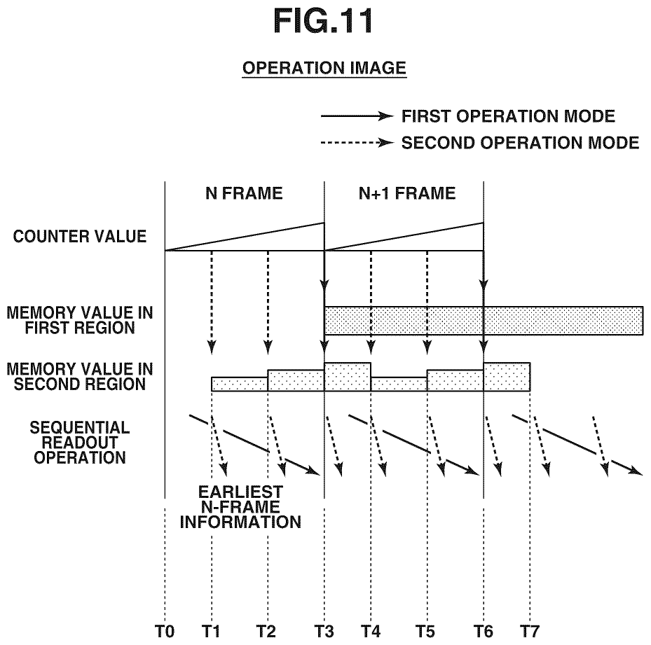

A second exemplary embodiment will now be described with reference to FIGS. 10 and 11. FIG. 10 schematically illustrates setting regions for the first region and the second region in a pixel array of a photoelectric conversion device according to the second exemplary embodiment. In the present exemplary embodiment, a part of the pixel region 12 is set as the first region and a region that does not overlap the first region in the pixel region 12 is set as the second region.

FIG. 11 illustrates a readout operation of the photoelectric conversion device according to the second exemplary embodiment.

In the present exemplary embodiment, the first region and the second region are set such that the first region and the second region do not overlap each other. With this configuration, the signal holding period in the memory corresponding to the pixels in the first region can overlap the signal holding period in the memory corresponding to the pixels in the second region. In other words, the operation of reading out signals corresponding to the second region can be performed even before the operation of reading out signals corresponding to the first region is completed. A readout operation in the second operation mode may be additionally performed during the readout operation in the first operation mode.

FIG. 11 illustrates an example where both the N-frame and the (N+1)-frame include sub-frames. For example, the N-frame includes sub-frames N_1, N_2, and N_3,and the (N+1)-frame includes sub-frames N_4, N_5, and N_6. The N-frame includes the period from time T0 to time T3 as a count period, and the (N+1)-frame includes the period from time T3 to time T6 as a count period.

The sub-frame N_1 includes a count period from time T0, which is the start time of the N-frame, to time T1, and the sub-frame N_2 includes a count period from time T0 to time T2. The sub-frame N_3 includes a count period from time T0 to time T3.

The sub-frame N_4 includes a count period from time T3 to time T4. The sub-frame N_5 includes a count period from time T3 to time T5. The sub-frame N_6 includes a count period from time T3 to time T6.

The count value for the signals corresponding to the pixels in the second region among the signals based on electric charges counted during the period from time T0 to time T1 in the sub-frame N_1 starting from time T0 is read out and held in the memory at time T1. The count value held in the memory is read out from the memory before time T2 by the readout operation to be sequentially performed in the second operation mode. After the count value is read out from the memory, the counter is not reset, and the count operation is continued.

The count value for the signals corresponding to the pixels in the second region among the signals based on electric charges counted during the period from time T0 to time T2 are read out and held in the memory at time T2. The count value held in the memory is read out from the memory before time T3 by the readout operation to be sequentially performed in the second operation mode. After the count value is read out from the memory, the counter is not reset, and the count operation is continued.

The count value for the signals corresponding to the pixels in the second region among the signals based on the electric charges counted during the period from time T0 to time T3 is read out and held in the memory at time T3. After the count value is read out and held in the memory, the counter is reset to the initial value. The count value held in the memory is read out from the memory before time T4 by the readout operation to be sequentially performed in the second operation mode. After the count value is read out from the memory, the memory is reset to the initial value. The count value for the signals corresponding to the pixels in the first region among the signals based on electric charges counted during the period from time T0 to time T3 is read out and held in the memory at time T3. After the count value is read out and held in the memory, the counter is reset to the initial value. The count value held in the memory is read out from the memory before time T6 by the readout operation to be sequentially performed in the first operation mode. After the count value is read out from the memory, the memory is reset to the initial value.

The count value for the signals corresponding to the pixels in the second region among the signals based on electric charges counted during the period from time T3 to time T4 is read out and held in the memory at time T4. The count value held in the memory is read out from the memory before time T5 by the readout operation to be sequentially performed in the second operation mode. After the count value is read out from the memory, the counter is not reset, and the count operation is continued.

The count value for the signals corresponding to pixels in the second region among the signals based on electric charges counted during the period from time T3 to time T5 is read out and held in the memory at time T5. The count value held in the memory is read out from the memory before time T6 by the readout operation to be sequentially performed in the second operation mode. After the count value is read out from the memory, the counter is not reset, and the count operation is continued.

The signals corresponding to the pixels in the second region among the signals based on electric charges counted during the period from time T3 to time T6 are read out and held in the memory at time T6. After the count value is read out and held in the memory, the counter is reset to the initial value. The count value held in the memory is read out from the memory before time T7 by the readout operation to be sequentially performed in the second operation mode. After the count value is read out from the memory, the memory is reset to the initial value.

The signals corresponding to the pixels in the first region among the signals based on electric charges counted during the period from time T3 to time T6 are read out and held in the memory at time T6.

As described above, according to the second exemplary embodiment, the signal holding period in the memory corresponding to the pixels in the first region can overlap the signal holding period in the memory corresponding to the pixels in the second region. Consequently, it is possible to start the readout operation in the second operation mode at any timing, while preventing the timing of the readout operation from being determined by the time period of the readout operation in the first operation mode. In other words, information about the N-frame can be obtained at an earlier timing than in the first exemplary embodiment, so that image recognition can be performed more rapidly.

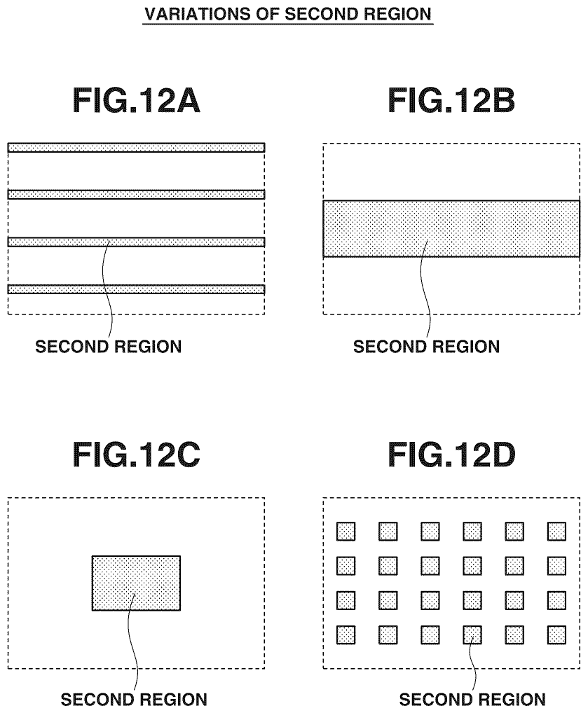

FIGS. 12A to 12D illustrate variations of layout examples of the second region in the pixel region 12.

FIG. 12A illustrates a layout example of the second region according to the second exemplary embodiment. This layout example is suitable for detection of an object that transitions in a direction intersecting a longitudinal direction of the second region in the entire image capturing region.

FIG. 12B illustrates a layout example in which a central portion of the pixel region 12 is included and the second region extends in a band shape in a horizontal direction from an end of the pixel region 12 to another end of the pixel region 12. FIG. 12C illustrates a layout example in which the rectangular or substantially rectangular second region is located in the central portion of the pixel region 12. The portion where the second region is located in the pixel region 12 is not limited to the central portion of the pixel region 12, but instead may be located near the upper side, near the lower side, near the left side, near the right side, or near any one of four corners of the pixel region 12. The shape of the second region is not limited to a rectangular shape or a square, but instead may be a circular shape such as an elliptic shape or a round shape, or a substantially circular shape. Not only a single region, but also a plurality of regions can be set as the second region in the pixel region 12.

If a region of interest can be identified in advance based on characteristics of the subject or the like, the region of interest as illustrated in, for example, FIGS. 12B and 12C can be set as the second region. Here, examples of the characteristics of the subject include the type of the subject, such as an oncoming vehicle, captured by an in-vehicle sensor.

FIG. 12D illustrates a layout example in which a plurality of discrete regions within the pixel region 12 is set as the second region.

As described above, in one embodiment, if the entire pixel region 12 is set as the second region, there is an issue that pixel information can be obtained only after a lapse of one frame period at earliest.

However, if the second region is located as illustrated in FIG. 12D, subject detection processing on the entire pixel region 12 can be performed in a pseudo manner at an earlier timing than one frame period.

The position and range of the second region can be set based on at least one of device information, installation information, and environmental information. The term “device information” as used herein refers to sensor characteristic information, such as the size of the pixel region 12 and the number of pixels, and optical characteristic information, such as the angle of view and resolution of the optical system 601. The term “installation information” as used herein refers to information about the installation state of the photoelectric conversion device, such as the installation height, angle (inclination angle from a horizontal plane), and orientation (azimuth angle within the horizontal plane) of the photoelectric conversion device. The term “environmental information” as used herein refers to information about the surrounding environment of the photoelectric conversion device. One example of the environmental information is information about a moving body incorporating a sensor. The position and range of the second region can also be set based on other information, such as vehicle speed information, acceleration information, steering angle information, brake information, and engine information. Other examples of information can also be applicable, such as the presence or absence of traffic participants (pedestrians, motorcycles, automobiles, and the like around the moving body), and the position, speed, acceleration, and distance of traffic participants, map information, global positioning system (GPS) information, road status, road surface state, weather information, surrounding brightness, and time. The layout of the second region may be set depending on, for example, distance information indicating a distance from the photoelectric conversion device 100 to the subject.

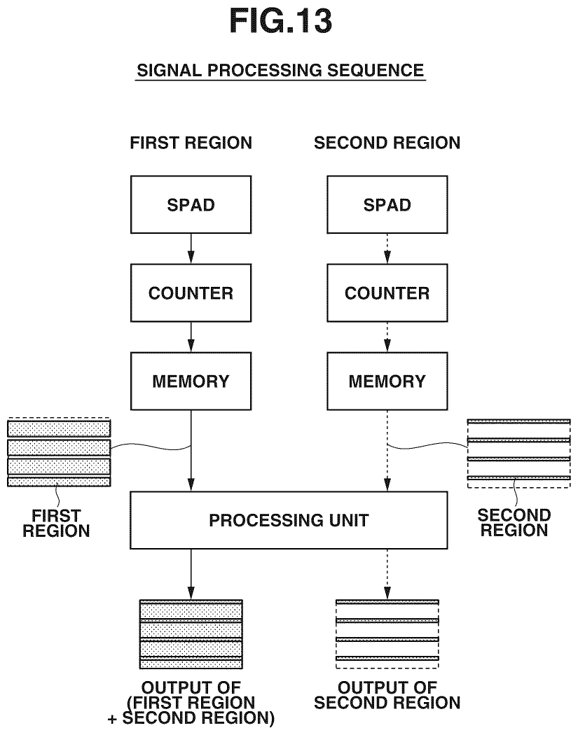

FIG. 13 illustrates a signal processing sequence according to the first exemplary embodiment.

The signals corresponding to electric charges generated in the APD 201 located in the first region are input to a processing unit via the counter and the memory. Similarly, the signals corresponding to electric charges generated in the APD 201 located in the second region are input to the processing unit via the counter and the memory.

If the signals read out by the readout operation are directly output to the outside of the sensor, the read out signals corresponding to the pixels arranged in the first region and the read out signals corresponding to the pixels arranged in the second region coexist are mixed. As illustrated in FIG. 13, the processing unit implements a sequence for outputting the signals corresponding to the pixels arranged in the second region and a sequence for outputting signals obtained by combining the signals corresponding to the pixels arranged in the first region with the signals corresponding to the pixels arranged in the second region in the sensor. The provision of the processing unit configured to perform such processing makes it possible to obtain the photoelectric conversion device capable of outputting data on which signal processing can be easily performed.

A photoelectric conversion system according to a third exemplary embodiment will now be described with reference to FIG. 14. FIG. 14 is a block diagram illustrating a schematic configuration of the photoelectric conversion system according to the third exemplary embodiment.

The photoelectric conversion devices (image capturing devices) described in the first and second exemplary embodiments can be applied to various photoelectric conversion systems. Examples of applicable photoelectric conversion systems include a digital still camera, a digital camcorder, a monitoring camera, a copying machine, a facsimile machine, a mobile phone, an in-vehicle camera, and an observation satellite. Applicable photoelectric conversion systems also include a camera module including an optical system such as a lens and an image capturing device. FIG. 14 is a block diagram illustrating a digital still camera as an example of such photoelectric conversion systems.

The photoelectric conversion system illustrated in FIG. 14 includes an image capturing device 1004 as an example of the photoelectric conversion device, and a lens 1002 for causing the image capturing device 1004 to form an optical image of a subject. The photoelectric conversion system further includes a diaphragm 1003 for changing the amount of light to pass through the lens 1002, and a barrier 1001 for protecting the lens 1002. The lens 1002 and the diaphragm 1003 are optical systems for focusing light on the image capturing device 1004. The image capturing device 1004 is any one of the photoelectric conversion devices (image capturing devices) according to the exemplary embodiments described above, and converts the optical image formed by the lens 1002 into an electric signal.

The photoelectric conversion system further includes a signal processing unit 1007 serving as an image generation unit for generating an image by performing processing on an output signal to be output from the image capturing device 1004. The signal processing unit 1007 performs an operation of various correction and compression processes, as needed, to output image data. The signal processing unit 1007 may be formed in or on a semiconductor substrate provided with the image capturing device 1004, or may be formed in or on another semiconductor substrate different from the semiconductor substrate provided with the image capturing device 1004. The image capturing device 1004 and the signal processing unit 1007 may be formed in or on the same semiconductor substrate.

The photoelectric conversion system further includes a memory unit 1010 for temporarily storing image data, and an external interface (I/F) unit 1013 for communicating with an external computer or the like. The photoelectric conversion system further includes a storage medium 1012, such as a semiconductor memory, for storing or reading out image capturing data, and a storage medium control I/F unit 1011 for storing data in the storage medium 1012 or reading out data from the storage medium 1012. The storage medium 1012 may be incorporated in or detachably attached to the photoelectric conversion system.

The photoelectric conversion system further includes an overall control/calculation unit 1009 that controls various types of arithmetic operations and the entire digital still camera, and a timing generation unit 1008 that outputs various types of timing signals to the image capturing device 1004 and the signal processing unit 1007. The timing signals and the like may also be input from an external device. The photoelectric conversion system may include at least the image capturing device 1004 and the signal processing unit 1007 that processes the output signal output from the image capturing device 1004.

The image capturing device 1004 outputs the image capturing signal to the signal processing unit 1007. The signal processing unit 1007 performs predetermined signal processing on the image capturing signal output from the image capturing device 1004, and outputs image data. The signal processing unit 1007 generates an image using the image capturing signal.

As described above, according to the third exemplary embodiment, the photoelectric conversion system to which any one of the photoelectric conversion devices (image capturing devices) according to the exemplary embodiments described above is applied can be achieved.

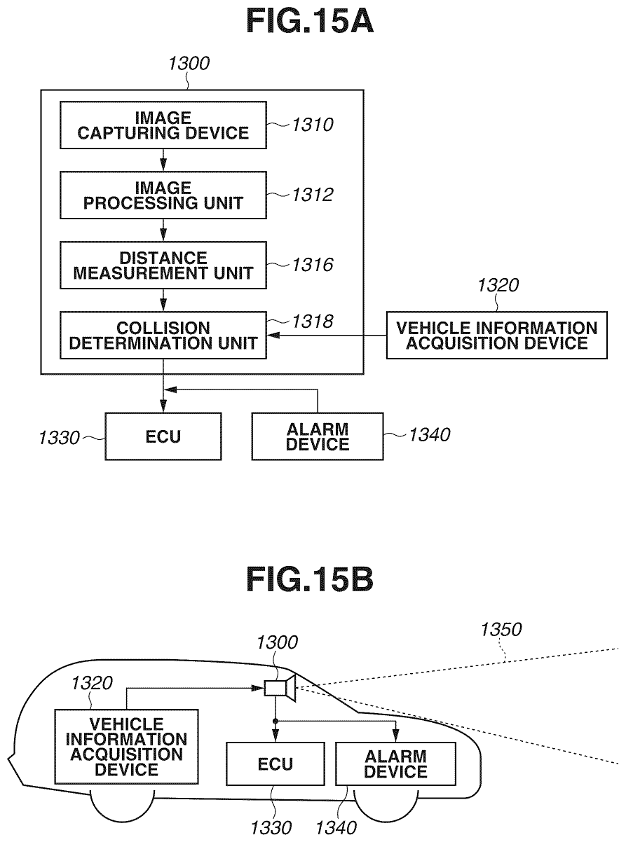

A photoelectric conversion system and a moving body according to a fourth exemplary embodiment will now be described with reference to FIGS. 15A and 15B. FIGS. 15A and 15B illustrate configurations of the photoelectric conversion system and the moving body according to the fourth exemplary embodiment.

FIG. 15A illustrates an example of the photoelectric conversion system for an in-vehicle camera. A photoelectric conversion system 1300 includes an image capturing device 1310. The image capturing device 1310 is any one of the photoelectric conversion devices (image capturing devices) according to the exemplary embodiments described above. The photoelectric conversion system 1300 also includes an image processing unit 1312 that performs image processing on a plurality of pieces of image data acquired by the image capturing device 1310. The photoelectric conversion system 1300 also includes a distance measurement unit 1316 that calculates a distance to an object, and a collision determination unit 1318 that determines whether there is a possibility of collision based on the calculated distance. The distance measurement unit 1316 may acquire distance information about a distance to a Time of Flight (ToF) object, or may acquire distance information using parallax information or the like. Specifically, the distance information is information about a parallax, a defocus amount, a distance to an object, or the like. The collision determination unit 1318 may determine the possibility of collision using any one of these pieces of distance information. A distance information acquisition unit may be implemented by exclusively designed hardware or a software module. The distance information acquisition unit may also be implemented by a field programmable gate array (FPGA), an ASIC, or the like, or a combination thereof.

The photoelectric conversion system 1300 is connected to a vehicle information acquisition device 1320, and is configured to acquire vehicle information, such as a vehicle speed, a yaw rate, and a steering angle. Further, an engine control unit (ECU) 1330 is connected to the photoelectric conversion system 1300. The ECU 1330 is a control device that outputs, on the basis of a determination result from the collision determination unit 1318, a control signal for causing the vehicle to generate a braking force. The photoelectric conversion system 1300 is also connected to an alarm device 1340 that issues an alarm to a driver based on the determination result from the collision determination unit 1318. For example, if there is a high possibility of collision based on the determination result from the collision determination unit 1318, the ECU 1330 performs vehicle control to avoid a collision or reduce damage by braking, releasing the accelerator, controlling the engine output, or the like. The alarm device 1340 alerts a user by sounding an alarm, displaying alarm information on the screen of, for example, a car navigation system, or vibrating the seat belt or the steering wheel.

The photoelectric conversion system 1300 according to the present exemplary embodiment captures images around the vehicle, for example, images of views in front of or behind the vehicle. FIG. 15B illustrates the photoelectric conversion system 1300 in a case of capturing images of views in front of the vehicle (image capturing range 1350). The vehicle information acquisition device 1320 sends an instruction to the photoelectric conversion system 1300 or the image capturing device 1310. This configuration can improve the accuracy of ranging.

The exemplary embodiment described above illustrates an example in which control for preventing a vehicle from colliding with another vehicle. However, the photoelectric conversion system 1300 can also be applied to, for example, control for automatic driving so as to follow other vehicles or control for automatic driving so as not to drive out of the lane. The photoelectric conversion system 1300 can be applied not only to vehicles such as automobiles, but also to, for example, a moving body (moving apparatus), such as a vessel, an airplane, or an industrial robot. Such a moving body includes one or both of a driving force generation unit that generates a driving force to be mainly used for movement of the moving body, and a rotary member to be mainly used for movement of the moving body. The driving force generation unit may be an engine, a motor, or the like. The rotary member may be a tire, a wheel, a screw of a vessel, a propeller of a flight vehicle, or the like. The photoelectric conversion system 1300 can be applied not only to moving bodies, but also to a wide range of apparatuses using object recognition, such as an intelligent transportation system (ITS).

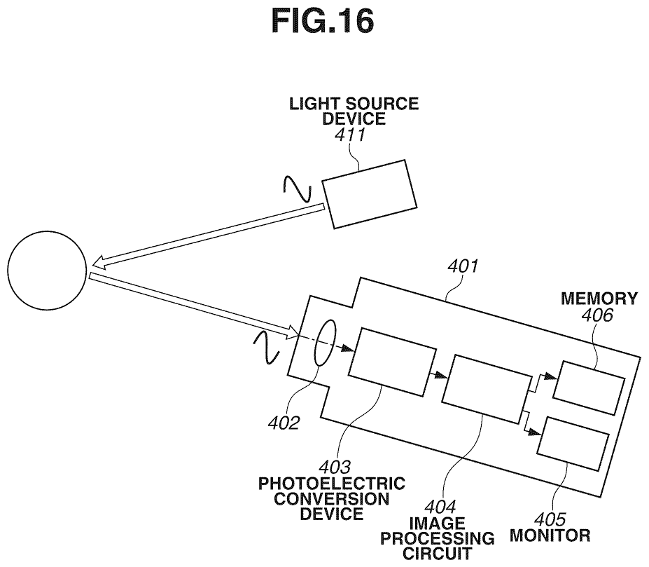

A photoelectric conversion system according to a fifth exemplary embodiment will now be described with reference to FIG. 16. FIG. 16 is a block diagram illustrating a configuration example of a distance image sensor serving as the photoelectric conversion system according to the fifth exemplary embodiment.

As illustrated in FIG. 16, a distance image sensor 401 includes an optical system 402, a photoelectric conversion device 403, an image processing circuit 404, a monitor 405, and a memory 406. The distance image sensor 401 is configured to receive light emitted from a light source device 411 to a subject and reflected by the surface of the subject (modulated light or pulsed light), thereby acquiring a distance image corresponding to the distance to the subject.

The optical system 402 includes one or more lenses. The optical system 402 guides image light (incident light) from the subject to the photoelectric conversion device 403, and forms an image on a light receiving surface (pixel region 12) of the photoelectric conversion device 403.

As the photoelectric conversion device 403, any one of the photoelectric conversion devices according to the exemplary embodiments described above is applied. A distance signal representing a distance obtained from a light reception signal and output from the photoelectric conversion device 403 is supplied to the image processing circuit 404.

The image processing circuit 404 performs image processing to construct the distance image based on the distance signal supplied from the photoelectric conversion device 403. The distance image (image data) obtained through the image processing is supplied and displayed on the monitor 405, or supplied to and stored (recorded) in the memory 406.

The above-described photoelectric conversion device is applied to the distance image sensor 401 having a configuration described above, thereby making it possible to acquire, for example, an accurate distance image with the improvement in characteristics of pixels.

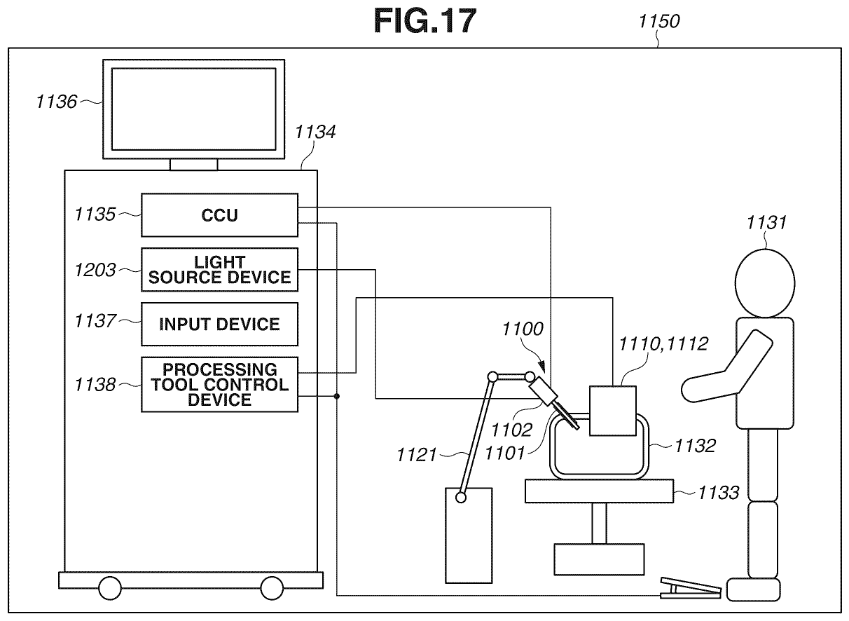

A photoelectric conversion system according to a sixth exemplary embodiment will now be described with reference to FIG. 17. FIG. 17 illustrates a schematic configuration example of a endoscopic surgery system serving as an example of the photoelectric conversion system according to the sixth exemplary embodiment.

FIG. 17 illustrates a state where an operator (doctor) 1131 performs a surgery on a patient 1132 on a patient bed 1133 using a endoscopic surgery system 1150. As illustrated in FIG. 17, the endoscopic surgery system 1150 includes an endoscope 1100, a surgical instrument 1110, and a cart 1134 on which various devices for endoscopically controlled surgery are placed.

The endoscope 1100 includes a lens barrel 1101 and a camera head 1102. A region of the endoscope 1100 at a predetermined length from a distal end thereof is inserted into the body cavity of the patient 1132. The camera head 1102 is connected to a proximal end of the lens barrel 1101. In the illustrated example, the endoscope 1100 is configured as a so-called hard mirror including the hard lens barrel 1101. Alternatively, the endoscope 1100 may be configured as a so-called soft mirror including a soft lens barrel.

The distal end of the lens barrel 1101 is provided with an opening into which an objective lens is fit. A light source device 1203 is connected to the endoscope 1100. Light generated by the light source device 1203 is guided to the distal end of the lens barrel 1101 by a light guide extending in the lens barrel 1101. The light is radiated toward an observation target within the body cavity of the patient 1132 through the objective lens. The endoscope 1100 may be a forward-viewing endoscope, an oblique-viewing endoscope, or a side-viewing endoscope.

An optical system and a photoelectric conversion device are provided within the camera head 1102, and reflected light (observation light) from the observation target is focused on the photoelectric conversion device by the optical system. The observation light is photoelectrically converted by the photoelectric conversion device, thereby generating an electric signal corresponding to the observation light, or an image signal corresponding to the observation image. Any one of the photoelectric conversion devices (image capturing devices) according to the exemplary embodiments described above can be used as the photoelectric conversion device. The image signal is transmitted as raw data to a camera control unit (CCU) 1135.

The CCU 1135 is composed of a CPU, a graphics processing unit (GPU), or the like, and controls operations of the endoscope 1100 and a display device 1136 in an integrated manner. The CCU 1135 also receives an image signal from the camera head 1102 and performs various image processing for displaying an image based on the image signal, such as development processing (demosaicing processing), on the image signal.

The display device 1136 displays an image based on the image signal on which image processing is performed by the CCU 1135 under the control of the CCU 1135.

The light source device 1203 is composed of a light source such as a light-emitting diode (LED), and supplies irradiated light to the endoscope 1100 when an image of a surgery site or the like is captured.

An input device 1137 is an input I/F for the endoscopic surgery system 1150. A user can input various information and instructions to the endoscopic surgery system 1150 through the input device 1137.

A processing tool control device 1138 controls driving of an energy processing tool 1112 for cauterization or incision of a tissue, blood vessel sealing, or the like.

The light source device 1203 that supplies irradiated light to the endoscope 1100 when an image of a surgery site is captured can be composed of, for example, a white light source formed of an LED, a laser light source, or a combination thereof. In a case where the white light source is formed of a combination of RGB laser light sources, an output intensity and an output timing of each color (each wavelength) can be accurately controlled. Thus, the light source device 1203 can adjust the white balance of the captured image. In this case, laser light from each of the RGB laser light sources is radiated to the observation target by time division, and driving of an image sensor of the camera head 1102 is controlled in synchronization with the irradiation timing, thereby making it possible to capture images respectively corresponding to RGB laser light sources by time division. According to this method, a color image can be obtained without providing any color filter in the image sensor.

Driving of the light source device 1203 may be controlled such that the intensity of light to be output is changed at every predetermined time interval. It is possible to form an image with a high dynamic range without causing a so-called black underexposure picture image and whiteout by driving the image sensor of the camera head 1102 to be synchronized with the timing of changing the light intensity to obtain images by time division and combine the images.

The light source device 1203 may be configured to supply light in a predetermined wavelength band corresponding to a special light observation. The special light observation uses, for example, the wavelength dependence of absorption of light in a body tissue. Specifically, the special light observation captures an image of a predetermined tissue, such as a blood vessel on a mucous surface, with a high contrast by using radiating light with a bandwidth narrower than that of irradiated light (i.e., white light) in a normal observation.

Alternatively, the special light observation may perform a fluorescent observation to obtain an image with fluorescence generated by excitation light radiation. In the fluorescent observation, it is possible to observe fluorescence from a body tissue by radiating excitation light to the body tissue, or obtain a fluorescence image by locally injecting reagent such as indocyanine green (ICG) into a body tissue and radiating excitation light corresponding to the fluorescence wavelength of the reagent to the body tissue. The light source device 1203 may be configured to supply narrow-band light and/or excitation light compatible with the special light observation.

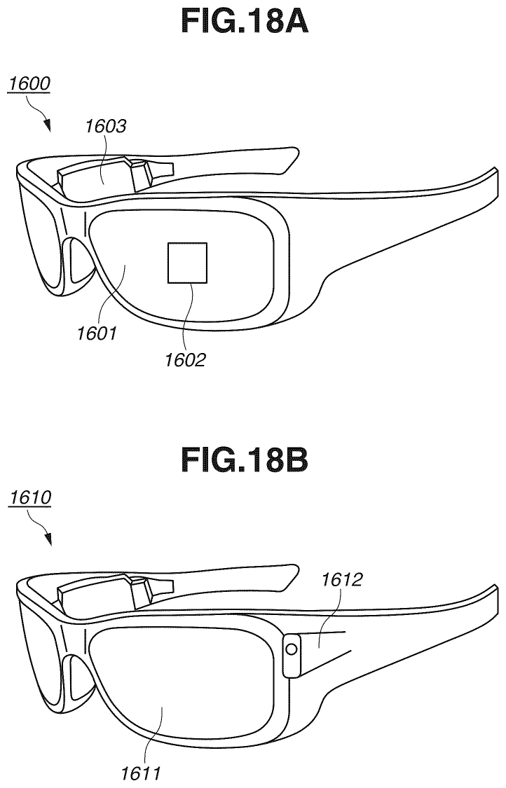

A photoelectric conversion system according to a seventh exemplary embodiment will now be described with reference to FIGS. 18A and 18B. FIG. 18A illustrates eyeglasses 1600 (smart glasses) serving as an example of the photoelectric conversion system according to the seventh exemplary embodiment. The eyeglasses 1600 include a photoelectric conversion device 1602. The photoelectric conversion device 1602 is any one of the photoelectric conversion devices (image capturing devices) according to the exemplary embodiments described above. On the back surface of a lens 1601, a display device including a light-emitting device, such as an organic LED (OLED) or an LED, may be provided. The number of the photoelectric conversion devices 1602 may be one but more. A combination of various types of photoelectric conversion devices may be used. The layout position of the photoelectric conversion device 1602 is not limited to that illustrated in FIG. 18A.

The eyeglasses 1600 further include a control device 1603. The control device 1603 functions as a power supply to supply power to the photoelectric conversion device 1602 and the above-described display device. The control device 1603 controls operations of the photoelectric conversion device 1602 and the display device. The lens 1601 is provided with an optical system for focusing light on the photoelectric conversion device 1602.

FIG. 18B illustrates eyeglasses 1610 (smart glasses) as an application example. The eyeglasses 1610 include a control device 1612. A photoelectric conversion device corresponding to the photoelectric conversion device 1602 and a display device are incorporated in the control device 1612. A lens 1611 is provided with the photoelectric conversion device included in the control device 1612, and with an optical system for projecting light from the display device. An image is projected on the lens 1611. The control device 1612 functions as a power supply to supply power to the photoelectric conversion device and the display device, and controls operations of the photoelectric conversion device and the display device. The control device 1612 may include a line-of-sight detection unit that detects the line of sight of a wearer. An infrared ray may be used to detect the line of sight. An infrared light-emitting unit emits infrared light to an eyeball of the user who is gazing at a display image. Reflected light of the emitted infrared light from the eyeball is detected by an image capturing unit including a light-receiving element, thereby obtaining a captured image of the eyeball. Provision of a reduction unit to reduce light from the infrared light-emitting unit to the display unit in a planar view makes it possible to reduce the deterioration in image quality.

The line of sight of the user on the display image is detected from the captured image of the eyeball obtained by image capturing using infrared light. For the detection of the line of sight using the captured image of the eyeball, any known technique can be applied. For example, a line-of-sight detection method based on Purkinje images by reflection of irradiated light on corneas can be used.

More specifically, line-of-sight detection processing is performed which is based on a pupillary and corneal reflex method. By using the pupillary and corneal reflex method, a line-of-sight vector representing the direction (rotation angle) of an eyeball can be calculated based on the image of the pupil and the Purkinje image included in the captured image of the eyeball, thereby detecting the line of sight of the user.

The display device according to the present exemplary embodiment may include a photoelectric conversion device having a light-receiving element, and may control a display image on the display device based on line-of-sight information about the user obtained from the photoelectric conversion device.

Specifically, the display device determines a first field-of-view region at which the user gazes and a second field-of-view region other than the first field-of-view region based on the line-of-sight information. The first field-of-view region and the second field-of-view region may be determined by a control device for the display device. Alternatively, the first field-of-view region and the second field-of-view region determined by an external control device may be received. In a display region of the display device, the display resolution of the first field-of-view region may be set to be higher than the display resolution of the second field-of-view region. In other words, the resolution of the second field-of-view region may be set to be lower than the resolution of the first field-of-view region.

The display region also includes a first display region and a second display region different from the first display region. One of the first display region and the second display region with a higher priority may be determined based on the line-of-sight information. The first field-of-view region and the second field-of-view region may be determined by the control device for the display device. Alternatively, the first field-of-view region and the second field-of-view region determined by an external control device may be received. The resolution of one of the regions with a high priority may be controlled to be higher than the resolution of a region other than the region with the high priority. In other words, the resolution of a region with a relatively low priority may be lowered.

Artificial intelligence (AI) may be used to determine the first field-of-view region or the region with a high priority. The AI may be a model configured to estimate, from an eyeball image, the angle of a line-of-sight and a distance to a target object along the line of sight by using the eyeball images and the actual directions of the eyeball images as teacher data. An AI program may be included in the display device, the photoelectric conversion device, or an external device. If the AI program is included in the external device, the result of the AI program is transmitted to the display device via communication.

In a case of display control based on visual detection, smart glasses further including a photoelectric conversion device that captures an external image can be suitably applied. The smart glasses can be configured to display captured external information in real time.

The photoelectric conversion devices and the photoelectric conversion systems described above may be applied to, for example, electronic apparatuses, such as smartphones and tablets.

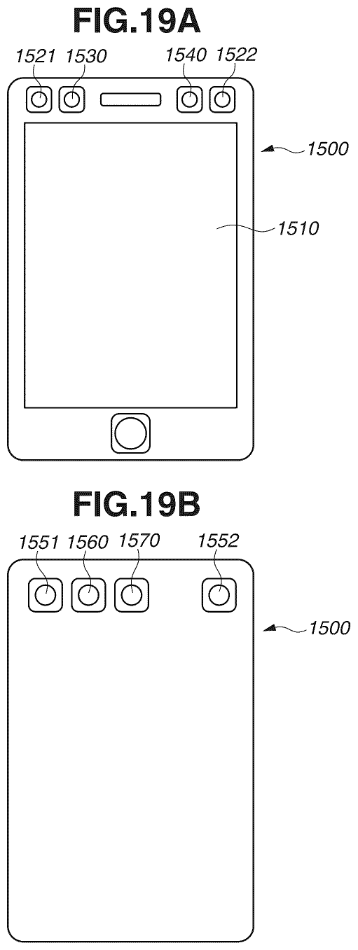

FIGS. 19A and 19B each illustrate an example of an electronic apparatus 1500 on which a photoelectric conversion device according to an eighth exemplary embodiment is mounted. FIG. 19A illustrates a front surface of the electronic apparatus 1500, and FIG. 19B illustrates a back surface of the electronic apparatus 1500.

As illustrated in FIG. 19A, a display 1510 that displays images is located at the center of the front surface of the electronic apparatus 1500. Along the upper side of the front surface of the electronic apparatus 1500, front cameras 1521 and 1522 each incorporating a photoelectric conversion device, an IR light source 1530 that emits infrared light, and a visible light source 1540 that emits visible light are located.

As illustrated in FIG. 19B, rear cameras 1551 and 1552 each incorporating a photoelectric conversion device, an IR light source 1560 that emits infrared light, and a visible light source 1570 that emits visible light are located along the upper side of the back surface of the electronic apparatus 1500.

For example, the electronic apparatus 1500 having a configuration as described above is capable of capturing high-quality images by applying any one of the photoelectric conversion devices described above. The photoelectric conversion devices can also be applied to electronic apparatuses, such as an infrared sensor, a ranging sensor using an active infrared light source, a security camera, and an individual or biometric authentication camera. With this configuration, the accuracy, performance, and the like of the electronic apparatuses can be improved.

While various apparatuses have been described above in the exemplary embodiments, a mechanical device may further be provided. A mechanical device in a camera is configured to drive components of an optical system to perform zooming, focusing, and a shutter operation. Alternatively, a mechanical device in a camera is configured to move a photoelectric conversion device to perform an image stabilization operation.

Other examples of the apparatuses include transport apparatus, such as a vehicle, a marine vessel, and a flight vehicle. The mechanical device in a transport apparatus may be used as a moving apparatus. The apparatus serving as a transport apparatus is suitable for transporting a photoelectric conversion device or assisting and/or automating driving (controlling) using an image capturing function. A processing apparatus for assisting and/or automating driving (controlling) can perform processing for operating a mechanical device serving as a moving apparatus based on information obtained by the photoelectric conversion device.

The exemplary embodiments are described above based on a configuration of a stacked sensor in which the sensor substrate 11 and the circuit substrate 21 are stacked. However, the exemplary embodiments are not limited to this example. All members illustrated in FIG. 3 may also be provided on a single substrate.

In this specification, the expressions, “A or B”, “at least one of A and B”, “at least one of A or/and B”, and “one or more of A and/or B” can include all possible combinations of enumerated items unless otherwise explicitly defined. In other words, it is to be understood that the above expressions include all of a case where at least one A is included, a case where at least one B is included, and a case where both of at least one A and at least one B are included. This also applies to a combination of three or more elements.

The above-described exemplary embodiments can be modified as appropriate without departing from the technical ideas of the disclosure. The disclosure in this specification encompasses not only what is described in this specification but also all matters discernible from this specification and the drawings attached to this specification. The disclosure in this specification includes a complement set of concepts described in this specification. In other words, if there is a statement in this specification, for example, that “A is larger than B”, this specification discloses that “A is not larger than B” even if the description “A is not larger than B” is omitted. This is because the description “A is larger than B” is based on the premise that the case of “A is not larger than B” is taken into account.

According to an aspect of the embodiments, it is possible to provide a photoelectric conversion device capable of reading out image data with a count period shorter than one frame period in a part of an image capturing range in the middle of the frame.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-187536, filed Nov. 1, 2023, which is hereby incorporated by reference herein in its entirety.

What is claimed is:

1. A device comprising:
a plurality of pixels each including a sensor unit configured to generate a signal upon incidence of a photon and a counter configured to count the signal; and
a control unit,
wherein a count value is generated based on a difference between a value held in the counter at a start of a count period and a value held in the counter at an end of the count period, and one frame includes at least a first count period and a second count period that is shorter than the first count period,
wherein the control unit causes the count value generated during the second count period to be output during a period from an end of the second count period and an end of the first count period,
wherein the sensor unit includes a first region and a second region, the first region including at least one pixel in which the signal is counted during the first count period among the plurality of pixels, the second region including at least one pixel in which the signal is counted during the second count period among the plurality of pixels,
wherein the second region is narrower than the first region, and
wherein the control unit continues counting in both the first region and the second region during a period from a start of the first count period to the end of the first count period.

2. The device according to claim 1, wherein the first region and the second region overlap each other.

3. The device according to claim 1, wherein the first region and the second region do not overlap each other.

4. The device according to claim 3,
wherein the device performs a first operation to output a first count value corresponding to the first region to an outside of the pixel, and a second operation to output a second count value corresponding to the second region to the outside of the pixel, and
wherein the device performs the second operation during the first operation.

5. The device according to claim 1, wherein the second count period and the first count period start simultaneously.

6. The device according to claim 1, wherein the end of the first count period coincides with an end of the one frame.

7. The device according to claim 1, wherein the plurality of pixels each includes a memory configured to store the count value of the counter.

8. The device according to claim 1, wherein the sensor unit includes a photodiode.

9. The device according to claim 1, wherein the control unit sets at least one of a position of the second region and a range of the second region based on at least one of device information, installation information, and environmental information.

10. The device according to claim 1, wherein the device sets the second region based on information regarding a distance from the device to an object.

11. A system comprising:
the device according to claim 1; and
a processing unit configured to generate an image by using a signal output from the device.

12. The system according to claim 11, wherein the second count period and the first count period start simultaneously.

13. The system according to claim 11, wherein the end of the first count period coincides with an end of the one frame.

14. The system according to claim 11, wherein the control unit sets at least one of a position of the second region and a range of the second region based on at least one of device information, installation information, and environmental information.

15. The system according to claim 11, wherein the device sets the second region based on information regarding a distance from the device to an object.

16. A moving body comprising:
the device according to claim 1; and
a control unit configured to control a movement of the moving body by using a signal output from the device.

17. The moving body according to claim 16, wherein the second count period and the first count period start simultaneously.

18. The moving body according to claim 16, wherein the end of the first count period coincides with an end of the one frame.

19. The moving body according to claim 16, wherein the control unit sets at least one of a position of the second region and a range of the second region based on at least one of device information, installation information, and environmental information.

20. The moving body according to claim 16, wherein the device sets the second region based on information regarding a distance from the device to an object.
